(19) United States
(12) Patent Application Publication
(10) Pub. No.: US 2006/0223561 A1
(43) Pub. Date: Oct. 5, 2006

(54) Base station bandwidth allocation for extending coverage within a cell

(76) Inventors: Christopher J. Capece, Lebanon, NJ (US); Behzad D. Mottahed, Upper Montclair, NJ (US)

Correspondence Address: CARLSON, GASKEY & OLDS, P.C., 400 W MAPLE RD, SUITE 350, BIRMINGHAM, MI, 48009, US

(21) Appl. No.: 11/095,056

(22) Filed: Mar. 31, 2005

(51) Int. Cl. H04B 7/00; H04Q 7/20

(52) U.S. Cl. 455/509; 455/66.1; 455/73

(57) ABSTRACT

A wireless communication system (20) utilizes a first frequency from a bandwidth provided by a base station (24) for communications between the base station (24) and mobile stations (26, 28) using at least one intermediary transceiver (42-52). The intermediary transceivers receive communications from at least one of the mobile stations (26, 28) or the base station (24) on the first frequency and transmit that communication on the first frequency. The intermediary transceivers (42-52) also transmit a corresponding relaying communication on a second frequency from the bandwidth provided by the base station (24). In this example, the second frequency along with other frequencies from the base station bandwidth provides wireless backhaul for communications between the intermediary transceivers, which are strategically located to extend coverage within a desired area, such as the interior of a building.

### FIELD OF THE INVENTION

This invention generally relates to telecommunications. More particularly, this invention relates to wireless communication systems.

### DESCRIPTION OF THE RELATED ART

Wireless communication systems are well known and in widespread use. A wireless communication network allows mobile stations such as cell phones, notebook computers or personal digital assistants to communicate with other mobile stations or wire-based devices. The wireless communication network communicates through a plurality of base stations that are arranged to provide wireless coverage over specific geographic areas or cells.

There are a variety of situations where a base station cannot provide coverage (i.e., adequate signal strength) throughout an entire cell. The interior of a building is one example area where wireless communication signals are not always available at a level to provide sufficient and reliable communications for individuals attempting to use a mobile station. Various approaches have been proposed to extend wireless communication coverage into areas that are not easily covered using existing wireless communication system infrastructure.

One proposal is to increase the number of base stations. The shortcoming of that approach is that it introduces considerable additional expense and there are physical limitations on where base stations can be located, for example. Another proposal is to increase transmission power. A shortcoming in this approach is that power levels are subject to regulation and can introduce undesirable interference if the power levels are not kept sufficiently low. While higher power may provide extended area coverage in some instances, it typically decreases overall service because of the additional interference and noise introduced with higher power transmissions.

Other approaches include installing antennas on or within buildings to act as repeaters of signals transmitted by a base station, for example. Wire-based repeaters are not practical for many situations because there is considerable material and labor expense involved in retrofitting a building to include sufficient cabling and devices to adequately extend wireless network communication coverage throughout a building.

Known over-the-air repeaters do not usually require such extensive wiring but they have limited application and do not provide adequate coverage for many situations. For example, over-the-air repeaters often are incapable of transmitting signals through walls or floors in a building.

It is desirable to be able to extend wireless network communication coverage into areas, such as the interior of a large building, that is otherwise difficult to reach. This invention addresses that need in an efficient and economical manner.

### SUMMARY OF THE INVENTION

An exemplary disclosed method of facilitating communications between a base station and a mobile station on at least a first frequency from a bandwidth associated with the base station includes using at least a first intermediary transceiver that wirelessly communicates with another intermediary transceiver using at least a second frequency from the bandwidth.

Using at least one frequency from the bandwidth as a backhaul between intermediary transceivers allows for wirelessly communicating between the intermediary transceivers to effectively extend radio frequency coverage into an area such as the interior of a building without requiring hardwire connections. Additionally, when the frequencies used for communications between intermediary transceivers are relatively low, the lower frequency communications are not hindered by barriers that typically plague previously known over-the-air repeaters.

One example method includes receiving a communication from at least one of a base station or a mobile station on the first frequency at a first intermediary transceiver. The received communication is also transmitted from the first intermediary transceiver on the first frequency. A relaying communication corresponding to the received communication is also transmitted from the first intermediary transceiver on the second frequency. In one example, another intermediary transceiver receives the relaying communication on the second frequency. The intermediate transceiver that received the relaying communication then transmits the original corresponding communication on the first frequency based upon the information contained in the relaying communication.

The relaying communication between intermediary transceivers allows for extending radio frequency, wireless network communication coverage throughout an area or building associated with the intermediary transceivers.

An example communication system includes a plurality of transceivers for receiving communications between a base station and a mobile station on a first frequency from a bandwidth associated with the base station. The plurality of intermediary transceivers transmit the received communications on the first frequency and wirelessly transmit relaying communications corresponding to the received communications between intermediary transceivers on a second frequency from the bandwidth.

The various features and advantages of this invention will become apparent to those skilled in the art from the following detailed description. The drawing that accompanies the detailed description can be briefly described as follows.

### BRIEF DESCRIPTION OF THE DRAWINGS

FIG. 1 schematically shows selected portions of a wireless communication system that utilizes a method designed according to an embodiment of this invention.

### DETAILED DESCRIPTION

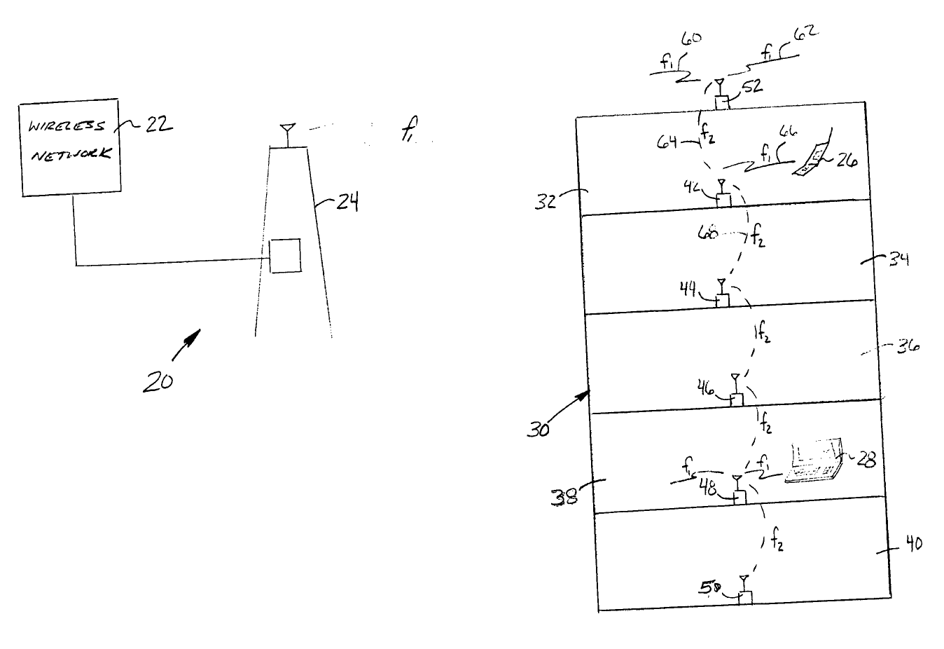

FIG. 1 schematically shows selected portions of a wireless communication system 20. A wireless network 22 comprises known components for facilitating communications between mobile stations such as cell phones, laptop computers, personal digital assistants or other known devices on the one hand and another mobile station or another type of communication device on the other hand.

The example wireless network 22 communicates with a plurality of base stations such as a base station 24. Each base station is situated to provide wireless communication coverage over a selected geographic region. The example base station 24 has a bandwidth associated with it. For example, a base station including a 15 MHz ratio portion provides a bandwidth of 11 carriers or frequencies useful for wireless communications. In this example, the base station 24 utilizes at least one of the frequencies from the base station's bandwidth for communications with mobile stations or other devices within the cell serviced by the base station 24. For purposes of discussion, the frequency used for communications between the base stations 24 and another portion of the wireless communication system 20 will be referred to as f₁.

The base station 24 communicates with mobile stations 26 and 28, for example, using the frequency f₁. In the illustrated example, the mobile stations 26 and 28 are located in a position where communications using f₁ are not possible or sufficiently reliable to facilitate the desired communications directly between the mobile stations and the base station 24. The illustration includes an area or section 30 of the cell serviced by the base station 24 in which the mobile stations 26 and 28 cannot achieve or receive an adequate signal to accomplish the desired wireless communications. In one example, the area 30 comprises a building within which it is difficult to achieve an adequate wireless communication signal directly between the base station 24 and one or more of the mobile stations. In this example, the building 30 includes a plurality of floors or levels 32, 34, 36, 38 and 40. Each one of the building levels has at least one intermediary transceiver 42, 44, 46, 48 and 50 for extending wireless communication coverage within a corresponding portion of the building. The illustrated example includes another intermediary transceiver 52 located outside of the building 30. In one example, the intermediary transceiver 52 is placed near an edge of a difficult-to-reach region. In the illustrated example, the intermediary transceiver is located on an exterior of the building 30.

The mobile stations 26 and 28 use the frequency f₁ for communications with the base station 24. The intermediary transceivers 42-52 (when possible) receive communications on f₁ from at least one of the base station 24 or a mobile station. When an intermediary transceiver receives such a communication, it retransmits that communication on the frequency f₁ and transmits a corresponding, relaying communication on another frequency f₂ from the base station's bandwidth for relaying the received communication to at least another one of the intermediary transceivers.

Considering the example of FIG. 1, the intermediary transceiver 52 receives a communication from the base station 24 on f₁. This is shown at 60 in FIG. 1. The intermediary transceiver 52 transmits that communication on f₁ as shown at 62. At 64, the intermediary transceiver 52 transmits a relaying communication to at least the intermediary transceiver 42 on f₂. The relaying communication on f₂ corresponds to the communication received by the intermediary transceiver 52 on f₁ from the base station 24. As schematically shown at 66, the intermediary transceiver 42 transmits the same communication received by the intermediary transceiver 52 on f₁ , using f₁ for the transmission. The intermediary transceiver 42 also transmits a corresponding, relaying communication on f₂ as shown at 68.

This process continues throughout the building or region 30. By strategically locating intermediary transceivers within a desired region or building of interest and utilizing a frequency from a base station's provided bandwidth, it is possible to extend coverage throughout a building or a region without requiring hardwired connections between the intermediate transceivers 42-52. Utilizing low power transmissions on a relatively lower frequency f₂ facilitates transmitting the relaying communications beyond barriers (i.e., through walls and floors of a building) to effectively extend wireless communication coverage within that building.

The transmission from the intermediary transceivers may be broadcast or directional in nature. Known techniques for directing beams from antennas to particular mobile stations, for example, are used in one example. In another example, each intermediary transceiver broadcasts transmitted signals across an area of coverage dictated by the design of the intermediary transceiver. Given this description, those skilled in the art will be able to select an appropriate arrangement to provide the nature of coverage desired for their particular situation.

Taking the example of FIG. 1, assume a first communication from the base station 24 on f₁ is intended for the mobile station 26. In one example, that communication is received by the intermediary transceiver 42 and then retransmitted at 66 for receipt by the mobile station 26. In another example, the intermediary transceiver 42, which provides coverage to the area 32 within which the mobile station 26 is located, cannot receive the signal directly from the base station 24. In this example, the intermediary transceiver 54 receives the communication from the base station 24 as schematically shown at 60. The intermediary transceiver 52 then relays that communication on f₂ as shown at 64 to the intermediary transceiver 42. As schematically shown at 66, the intermediary transceiver 42 responsively transmits the communication from the base station 24 on f₁ within the area 32 (i.e., on a level of a building) such that it can be received by the mobile station 26.

In another example, the mobile station 28 initiates a communication that needs to be received by the base station 24 for the wireless network 22 to direct it to an appropriate end point (i.e., a line-based telephone). As schematically shown at 70, the mobile station 28 transmits a communication that is received by the intermediary transceiver 48 on f₁. The intermediary transceiver 48 then transmits a relaying communication on f₂ that is received by the intermediary transceiver 46. Another relaying communication is transmitted on f₂ such that it is received by the intermediary transceiver 44, which again relays a communication on f₂ that is received by the intermediary transceiver 42. In this example, one more relaying communication on f₂ between the intermediary transceivers 42 and 52 allows the intermediary transceiver 52 to broadcast on f₁ a signal that is received by the base station 24. In this example, the intermediary transceiver 52 transmits the original communication from the mobile station 28 on f₁ to the base station 24 on f₁.

One advantage to the disclosed example is that it utilizes the frequencies or carriers already allocated to a base station bandwidth such that no additional Federal Communication Commission permissions are required. This allows for more readily extending coverage from existing base stations, for example.

In one example, the highest frequency from within a bandwidth provided by a base station is dedicated entirely to bearer traffic and control signal communications between the base station and any mobile stations within the cell serviced by that base station. Other examples will include using more than one frequency from the base station bandwidth for communications between the base station and mobile stations. At least one other frequency from the bandwidth provided by that base station is dedicated entirely to communications between the intermediary transceivers. Some examples will include using more than one frequency for communications between the transceivers. One efficiency of the disclosed example allows for one carrier or one frequency typically to be used for all communications with mobile stations within an area of coverage, such as the building 30, serviced utilizing intermediary transceivers.

One example includes allocating specific frequencies from within the bandwidth provided by a base station to communications between intermediary transceivers in a specific direction. For example, one of the frequencies may be dedicated to relaying received transmissions that are received from a base station (i.e., downlink). Another one of the frequencies may be dedicated to relaying communications corresponding to communications received from a mobile station intended for receipt by the base station (i.e., uplink). The frequencies from the base station bandwidth may also be allocated to bearer traffic and control traffic, respectively. Given this description, those skilled in the art will be able to arrange the frequencies from within a bandwidth provided by a base station in a manner to meet their particular needs.

The disclosed example provides an efficient and cost-effective way of extending wireless communication coverage into areas that are difficult to reach with existing wireless network infrastructure. Utilizing wireless communications between the intermediary transceivers in the disclosed example avoids the requirement to retrofit a building with wiring for repeaters, for example. Additionally, the disclosed example utilizes existing frequency allocation from existing base stations to achieve the results described above.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of facilitating communications between a base station and a mobile station, comprising:
receiving a communication at a first intermediary transceiver from at least one of the base station or the mobile station on at least a first frequency from a bandwidth associated with the base station; and
wirelessly communicating between the first intermediary transceiver and a second intermediary transceiver using at least a second frequency from the bandwidth.

2. The method of claim 1, comprising using the second frequency as a backhaul for relaying communications between the intermediary transceivers that correspond to communications between the base station and the mobile station.

3. The method of claim 1, comprising
transmitting the received communication from the first intermediary transceiver on the first frequency; and
transmitting a relaying communication corresponding to the received communication from the first intermediary transceiver on the second frequency.

4. The method of claim 3, comprising
receiving the relaying communication at the second intermediary transceiver on the second frequency; and
transmitting the communication received by the first intermediary transceiver from the second intermediary transceiver on the first frequency.

5. The method of claim 4, comprising transmitting the received relaying communication from the second intermediary transceiver on the second frequency.

6. The method of claim 1, comprising converting a signal received at the first intermediary transceiver on the first frequency to a corresponding signal for transmission by the first intermediary transceiver on the second frequency.

7. The method of claim 1, wherein the second frequency is a lower frequency than the first frequency.

8. The method of claim 1, comprising dedicating the entire first frequency to communications between the base station and the mobile station and dedicating the entire second frequency to communications between the intermediary transceivers.

9. The method of claim 1, wherein the bandwidth comprises a plurality of other frequencies and wherein the intermediary transceivers use at least one of the other frequencies for communications between the intermediary transceivers.

10. The method of claim 1, comprising using at least one other frequency from the bandwidth for communications between the base station and the mobile station.

11. The method of claim 1, comprising using the first frequency for bearer traffic and control traffic communications between the base station and the mobile station.

12. The method of claim 11, comprising using the first frequency for communications between the base station and a wireless communication network.

13. A communication system for facilitating communications between a base station and a mobile station that use a first frequency from a bandwidth associated with the base station, comprising:
a plurality of intermediary transceivers for:
receiving communications from at least one of the base station or the mobile station on the first frequency,
transmitting the received communications on the first frequency, and
wirelessly transmitting relaying communications corresponding to the received communications between the intermediary transceivers on a second frequency from the bandwidth.

14. The system of claim 13, wherein the transceivers convert a signal received on the first frequency to a corresponding signal for transmission to another one of the transceivers on the second frequency.

15. The system of claim 13, wherein the second frequency is a lower frequency than the first frequency.

16. The system of claim 13, wherein the entire first frequency is dedicated to communications between the base station and the mobile station and the entire second frequency is dedicated to communications between the intermediary transceivers.

17. The system of claim 13, wherein the intermediary transceivers use the second frequency as a backhaul for transmitting the relaying communications between the intermediary transceivers.

18. The system of claim 13, wherein at least a first one of the intermediary transceivers receives a communication from at least one of the base station or the mobile station on the first frequency and at least a second one of the intermediary transceivers receives the relaying communication on the second frequency and the second one of the intermediary transceivers uses the received relaying communication for transmitting the communication received by the first one of the intermediary transceivers from the second one of the intermediary transceivers on the first frequency.

19. The system of claim 18, wherein the second one of the intermediary transceivers transmits the received relaying communication on the second frequency.

20. A method of facilitating communications between at least one base station and at least one mobile station, comprising:
communicating between the base station and the mobile station on at least a first frequency from a bandwidth associated with the base station using at least a first intermediary transceiver; and
wirelessly communicating between the first intermediary transceiver and a second intermediary transceiver using at least a second frequency from the bandwidth.
